(19) United States
(12) Patent Application Publication
(10) Pub. No.: US 2012/0293557 A1
(43) Pub. Date: Nov. 22, 2012

(54) Object tracking apparatus, interactive image display system using object tracking apparatus, and methods thereof

(75) Inventors: Hao-Ming Hsu, HsinChu City (TW); Chun-Huang Lin, HsinChu City (TW); Chieh-Hsiung Chang, HsinChu City (TW)

(73) Assignee: Chip Goal Electronics Corporation, R.O.C.

(21) Appl. No.: 13/200,160

(22) Filed: Sep. 20, 2011

(30) Foreign Application Priority Data
May 18, 2011 (TW) TW 100117433

(51) Int. Cl. G09G 5/32; G06F 3/042

(52) U.S. Cl. 345/672; 345/175

(57) ABSTRACT

The present invention discloses an object tracking apparatus, an interactive image display system using the object tracking apparatus, and methods thereof. The object tracking apparatus generates a control signal inputted to an image display apparatus to display an image in response to an action of an object. The object tracking apparatus includes: an image sensor device, which detects a predetermined pattern displayed by the image display apparatus to generate a sensed image; a coordinate information generation circuit, which generates coordinate information according to the sensed image; and a processing circuit, which generates a predetermined image data based on which the predetermined pattern is generated, wherein the processing circuit compares the coordinate information with the predetermined image data to generate a correction value.

### CROSS REFERENCE

The present invention claims priority to TW 100117433, filed on May 18, 2011.

### BACKGROUND OF THE INVENTION

1. Field of Invention

The present invention relates to an object tracking apparatus, an interactive image display system using the object tracking apparatus, and methods thereof; particularly, it relates to such apparatus, system, and methods wherein an image which is displayed by an image display apparatus is corrected according to a predetermined pattern displayed by the image display apparatus.

2. Description of Related Art

FIG. 1 shows a prior art interactive image display system using an object tracking apparatus 100. As shown in FIG. 1, the object tracking apparatus 100 includes an image sensor device 10, a coordinate information generation circuit 20, and a processing circuit 30. The image sensor device 10 senses an action of a hand-held object (which for example is a pointer stick which emits infrared light, and the image sensor device 10 senses a position and a time period wherein the object stays at the position), and the sensed image is inputted to the coordinate information generation circuit 20. The coordinate information generation circuit 20 processes the sensed image and the processed result is inputted to the processing circuit 30. The processing circuit 30 generates image data which is inputted to an image display apparatus 40. Thus, the image display apparatus 40 displays an image related to the image data in response to the action of the hand-held object to create an interactive effect.

FIG. 2 shows the problems often encountered by the prior art interactive image display system mentioned above. The image display apparatus 40 receives image data 101, and it is intended for the image display apparatus 40 to display an image 102 exactly corresponding to the image data 101. However, due to factors such as the location of the image display apparatus 40, the curvature of a camera of the interactive image display system, the roughness of the projection screen, or other causes, the displayed image 102 often does not correctly present the predetermined image data 101 and there may be a shift, distortion, size change, tilt, or rotation in the displayed image 102. Furthermore, as shown in FIG. 2, the area 103 sensed by the image sensor device 10 and the display area 104 of the image display apparatus 40 are often not in consistence with respect to positions, sizes, tilt angles or rotation angles. The aforementioned problems cause errors and result in poor interactive effect. Therefore, these problems need to be solved by a correction procedure.

A correction procedure of the prior art interactive image display system is shown in FIG. 3. The image display apparatus 40 sequentially displays predetermined patterns one by one, such as multiple cross patterns shown in the figure. A user manually points a hand-held infrared pointer stick 50 to the presently displayed pattern at the time it is shown. The image sensor device 10 senses infrared light emitted from the hand-held infrared pointer stick 50, and the sensed result is inputted to the coordinate information generation circuit 20. The coordinate information generation circuit 20 processes the sensed result to generate coordinate information which is sent to the processing circuit 30. The processing circuit 30 compares the coordinate information with predetermined data to correlate the two for error correction. The aforementioned steps are repeated for every cross pattern to completely mapping the positions pointed to by the infrared pointer stick 50 to the area of the displayed image.

The aforementioned correction procedure needs to be performed manually and repeated a huge number of times, pointing the hand-held object to the displayed patterns according to the sequence displayed by the image display to point to several dozens of positions of the displayed patterns; this costs a long time and is not user-friendly.

In view of the foregoing, the present invention provides an object tracking apparatus, an interactive image display system using the object tracking apparatus, and methods thereof, to solve the problems mentioned above.

### SUMMARY OF THE INVENTION

The first objective of the present invention is to provide an object tracking apparatus.

The second objective of the present invention is provide an interactive image display system using the object tracking apparatus.

The third objective of the present invention is to provide methods of correcting an image.

To achieve the foregoing objectives, in one perspective of the present invention, it provides an object tracking apparatus, which generates a control signal according to an action of an object, the control signal being inputted to an image display apparatus to display an image in response to the action of the object, the object tracking apparatus including: an image sensor device, which detects at least a predetermined pattern displayed by the image display apparatus to generate a sensed image; a coordinate information generation circuit, which generates coordinate information according to the sensed image; and a processing circuit, which generates a predetermined image data based on which the predetermined pattern is generated, wherein the processing circuit compares the coordinate information with the predetermined image data to generate a correction value.

In another perspective of the present invention, it provides an interactive image display system, including: an image display apparatus; and an object tracking apparatus, which generates a control signal according to an action of an object, the control signal being inputted to an image display apparatus to display an image in response to the action of the object, the object tracking apparatus including: an image sensor device, which detects at least a predetermined pattern displayed by the image display apparatus to generate a sensed image; a coordinate information generation circuit, which generates coordinate information according to the sensed image; and a processing circuit, which generates a predetermined image data based on which the predetermined pattern is generated, wherein the processing circuit compares the coordinate information with the predetermined image data to generate a correction value.

In one embodiment, the processing circuit converts the coordinate information to the control signal according to the correction value.

In yet another perspective of the present invention, it provides a method of correcting an interactive image display system using an object tracking apparatus, wherein the object tracking apparatus generates a control signal according to an action of an object, the control signal being inputted to an image display apparatus to display an image in response to the action of the object, the method including: displaying at least a predetermined pattern by the image display apparatus according to a predetermined image data; sensing the predetermined pattern by an image sensor device to generating at least a sensed image; processing the sensed image to generate a coordinate information; and comparing the coordinate information with the predetermined image data to generate a correction value which is used for correcting the control signal, the image sensor device, or the image display apparatus.

In another perspective of the present invention, it provides a method of correcting an interactive image, including: displaying a predetermined center pattern in a display area according to a predetermined center image data; sensing the predetermined center pattern to generate a sensed image; processing the sensed image to generate a center coordinate information; comparing the center coordinate information with the predetermined center image data to generate a first correction value; and correcting the center coordinate information according to the first correction value, such that the center coordinate information is aligned with the predetermined center image data.

Instill another perspective of the present invention, it provides a method of correcting an image, including: displaying a plurality of predetermined edge patterns in a display area according to predetermined edge image data; sensing the predetermined edge patterns to generate a sensed image; processing the sensed image to generate edge coordinate information which includes a plurality of edge coordinates; comparing the edge coordinate information with the predetermined edge image data to generate a correction value; and correcting the edge coordinate information according to the correction value, such that the edge coordinate information is aligned with the predetermined edge image data.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art interactive image display system using an object tracking apparatus.

FIG. 2 shows the problems that a shift, distortion, size change, tilt, or rotation may occur in a displayed image so that it does not exactly present the image data.

FIG. 3 shows the correction procedure of the prior art interactive image display system.

FIG. 4 shows the basic structure of the present invention.

FIG. 5 shows an embodiment of the present invention.

FIG. 6 shows that an image sensor device 12 is sensing predetermined patterns displayed by the image display apparatus 40.

FIG. 7 shows a more specific embodiment of the present invention.

FIG. 8 shows another more specific embodiment of the present invention.

FIG. 9 shows another more specific embodiment of the present invention.

FIGS. 10A-10C show another more specific embodiment of the present invention.

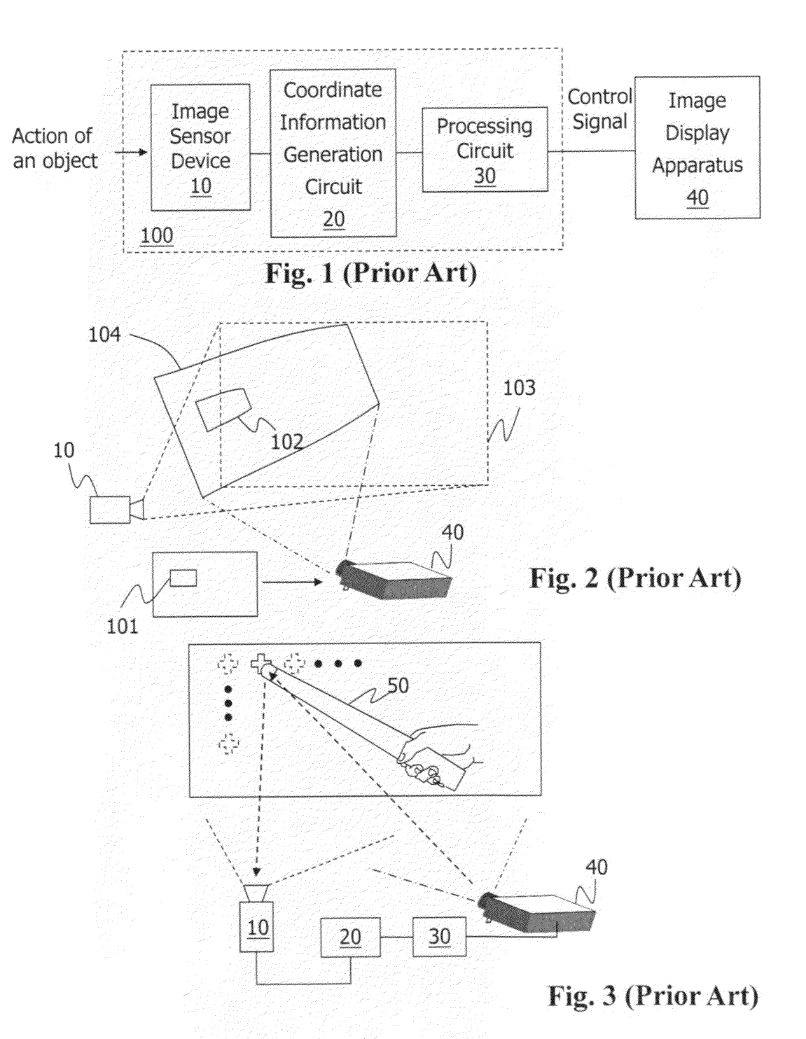

### DESCRIPTION OF THE PREFERRED EMBODIMENTS

The drawings as referred to throughout the description of the present invention are for illustration only, to show the interrelationships between the devices or structural members, but not drawn according to actual scale.

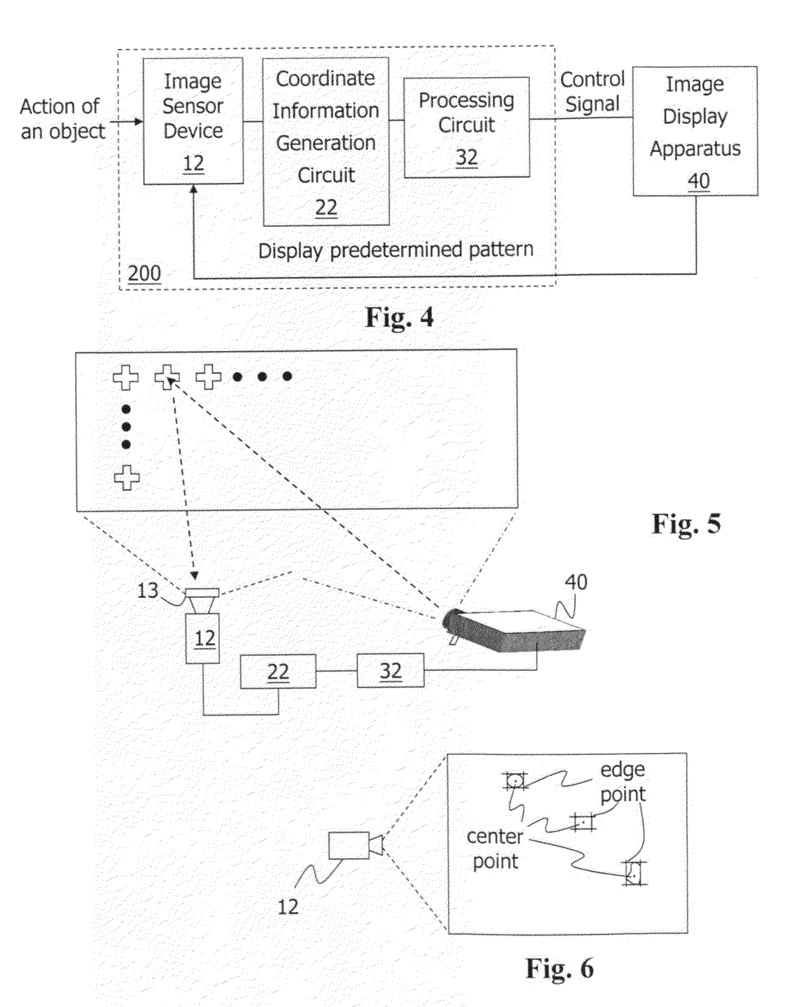

FIG. 4 shows the basic structure of the present invention. An object tracking apparatus 200 includes an image sensor device 12, a coordinate information generation circuit 22, and a processing circuit 32. The image sensor device 12 senses an action of a hand-held object, and inputs a sensed result to the coordinate information generation circuit 22. The hand-held object is for example but not limited to a hand-held pointer stick which emits infrared light, and the image sensor device 12 for example senses a position and a time period wherein the object stays at the position. The coordinate information generation circuit 22 processes the sensed result to generate coordinate information, which is inputted to the processing circuit 32. The processing circuit 32 generates a control signal which is inputted to the image display apparatus 40. As such, the image display apparatus 40 displays an image related to the control signal in response to the action of the hand-held object to create interactive effect, wherein the image display apparatus 40 is, for example but not limited to, a projector or a display screen.

Different from the prior art, the present invention does not need to perform the complicated positioning and alignment procedure manually. The correction procedure of the present invention is thus. The processing circuit 32 generates predetermined image data, and the image display apparatus 40 displays predetermined patterns according to the predetermined image data, wherein the predetermined image data for example include multiple coordinates. The predetermined patterns for example may be the cross patterns as shown in FIG. 5, or patterns of any other arbitrary shape and size, wherein a center point or any other predetermined point of one pattern corresponds to one coordinate of the predetermined image data. The predetermined patterns are displayed in any order sequentially or all at the same time. The image sensor device 12 senses the predetermined patterns displayed by the image display apparatus 40 to generate at least one sensed image which is inputted to the coordinate information generation circuit 22. The image sensor device 12 may sense the displayed predetermined patterns in a predetermined order or sense them at the same time according generation circuit 22 processes the sensed image to generate coordinate information which includes at least a coordinate, and inputs the coordination information to the processing circuit 32. Referring to FIG. 6, in a preferred embodiment, the coordinate information may include only a coordinate of the center point or a predetermined point (for example, an edge point) of the sensed image instead of the entire sensed image, to reduce the required storage space and calculation operation. Referring to FIG. 5, the processing circuit 32 compares the coordinate information with the predetermined image data to generate a correction value which may be used for correcting the control signal, the image sensor device 12, and/or the image display apparatus 40. It is described in the above that the predetermined image data includes one or multiple coordinates; in another embodiment, in addition to one or multiple coordinates, the predetermined image data may also include information of size, shape, wavelength, etc. of the predetermined patterns, and the coordinate information generated by the coordinate information generation circuit 22 preferably also include corresponding information for comparison. In the present invention, the number of the predetermined patterns displayed by the image display apparatus 40 can be as few as possible to reduce the required calculation, and the predetermined patterns do not need to be distributed all over the display area, as long as it is enough for obtaining the correction value that is capable of correlating the image displayed by the image display apparatus 40 (or the image sensed by the image sensor device 12) to the image data generated by the processing circuit 32 with a satisfied quality.

More specifically, due to the aforementioned inaccuracy factors of the image display apparatus 40 and the image sensor device 12, a shift, distortion, size change, tilt, or rotation may occur when a displayed predetermined pattern is sensed by the image sensor device 12. The error (of the shift, distortion, size change, tilt, or rotation) will be reflected in the difference between the coordination information and the predetermined image data. In the present invention, a user does not have to perform a complicated correction procedure manually; instead, the processing circuit 32 compares the coordinate information and the predetermined image data, and the correction is automatically completed by automatically correcting the control signal, the image sensor device 12, and/or the image display apparatus 40 according to the comparison result, or alternatively, information for correcting the control signal, the image sensor device 12, and/or the image display apparatus 40 can be generated and provided to a circuit or the user.

The correction may be accomplished for example by adjusting the control signal, or by adjusting the image sensor device 12 or the image display apparatus 40 mechanically or electronically, so that the image displayed by the image display apparatus 40 better meets the user's expectation. To mechanically adjust the image sensor device 12 and/or the image display apparatus 40 includes, for example but not limited to, adjusting the position, angle, focus, or other physical properties of a camera of the image sensor device 12 and/or the image display apparatus 40; To electronically adjust the image sensor device 12 and/or the image display apparatus 40 includes, for example but not limited to, adjusting a setting of the focus, sensible area, display area, resolution, or other electronic characteristics of the image sensor device 12 and/or the image display apparatus 40.

The predetermined pattern displayed by the image display apparatus 40 may include pattern formed by light within a predetermined wavelength range, for example but not limited to red light, yellow light, blue light, or other lights. The image sensor device 12 may further include a filter 13 (referring to FIG. 5) in front of the camera, for filtering light out of the predetermined wavelength range to further improve the accuracy of correction. The filter 13 may be a single filter or a filter set including multiple filters; in the latter case, in one embodiment, the multiple filters can be switched from one to another manually or automatically. For example, during the correction procedure, a blue light filter may be used for increasing the accuracy of distinguishing a blue predetermined pattern displayed by the image display apparatus 40, while during a normal operation with a pointer stick 50 which emits infrared light, the blue light filter is manually or automatically replaced by an infrared filter in the filter set.

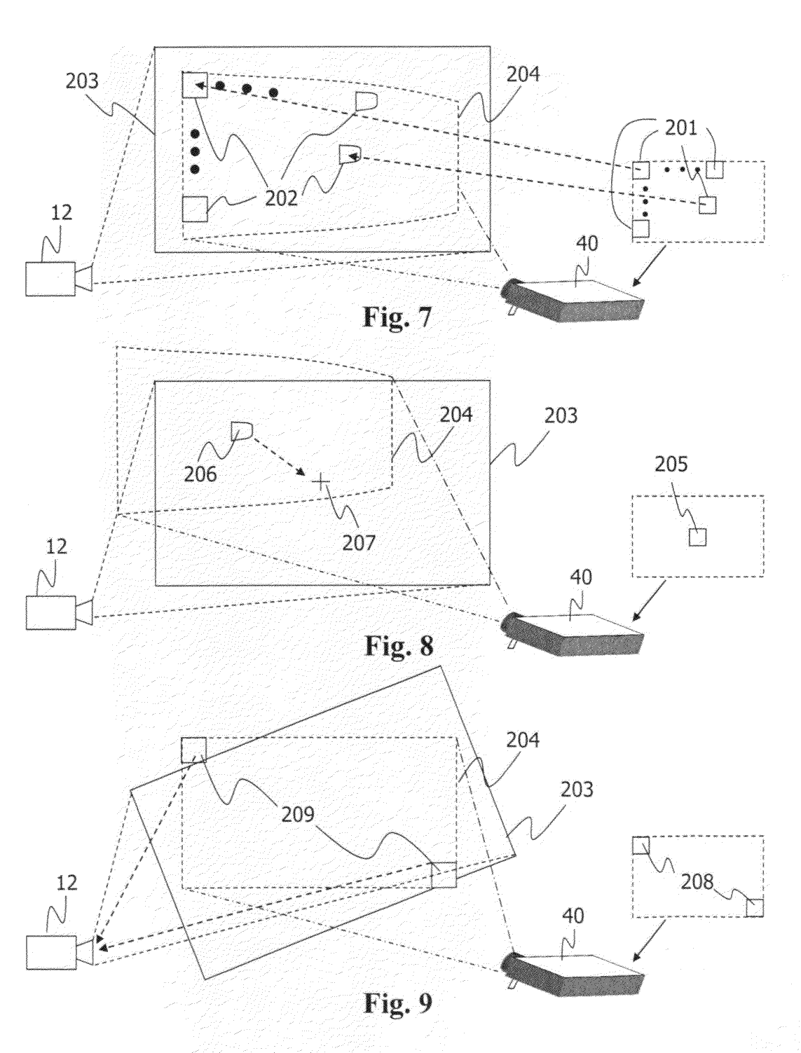

FIG. 7 shows a more specific embodiment of the present invention. This embodiment shows how the correction procedure of the interactive image display apparatus is performed. As shown in the figure, the image display apparatus 40 has a display area 204, and the image sensor device 12 has a sensible area 203. Multiple predetermined patterns 202 are displayed in the display area 204 by the image display apparatus 40 according to predetermined image data 201. The display area 204 is distorted as shown in the figure. The image sensor device 12 senses each predetermined pattern 202 (with a filter for a predetermined wavelength range, if desired), and the sensed image is processed by the coordinate information generation circuit 22, followed by the operation of the processing circuit 32. The difference between the coordinate(s) of each predetermined pattern 202 and the predetermined image data 201 can be calculated to obtain the degree of distortion, i.e., the correction value can be obtained. The distortion can be corrected for example by using a servo motor to adjust the mechanical position of the image sensor device 12 and/or the image display apparatus 40, or by tuning other related parameters thereof. As a result, when the user holds a hand-held object and points it to any position in the display area 204, the image display apparatus 40 can display a corrected image according to the correction value in response to the action of the hand-held object.

Besides the mismatches corrected by the aforementioned correction procedure, there may be other mismatches between the display area 204 of the image display apparatus 40 and the sensible area 203 of the image sensor device 12 that need to be corrected. For example, the sensible area 203 may not cover the entire display area 204, or a large shift, rotation, or other mismatches may exist between the sensible area 203 and the display area 204. The present invention also provides solutions to such problems. FIGS. 8-9 show correction procedures of the present invention for the aforementioned mismatches. As shown in FIG. 8, a predetermined center point image data 205 (which does not have to be the exact center point but can be a point in vicinity around the center point) is inputted to the image display apparatus 40, and a predetermined center pattern 206 is displayed. When a shift between the display area 204 and the sensible area 203 is large, there is a significant shift between the predetermined center pattern 206 of the display area 204 and a center point 207 of the sensible area 203, as indicated by the dashed arrow line shown in the figure. The sensed image obtained by the image sensor device 12 which senses the predetermined center pattern 206 is processed by the coordinate information generation circuit 22, followed by the operation of the processing circuit 32. More specifically, center point coordinate information is generated by the coordinate information generation circuit 22, and it is compared with the predetermined center point image data 205 by the processing circuit 32 to generate shift information between the predetermined center pattern 206 and the center point 207 of the sensible area 203. As such, a proper correction value can be generated, and based on the correction value, the predetermined center pattern 206 of the display area 204 can be adjusted to be aligned with the center point 207 of the sensible area 203 (i.e., the center point coordinate information matches the predetermined center point image data 205) by a corresponding adjustment. The mismatch can be corrected for example by adjusting the mechanical position of the image sensor device 12 and/or the image display apparatus 40 by a servo motor, or by tuning other related parameters thereof. Alternatively, information for correcting the mismatch can be shown as a tuning guide to the user.

An embodiment to show information for correcting the mismatch as a tuning guide to the user is described below. The predetermined center point image data 205 is inputted to the image display apparatus 40, and the predetermined center pattern 206 (which may include one or multiple points) is displayed correspondingly. Next, the image sensor device 12 senses the predetermined center pattern 206 and generates a sensed image. The sensed image is processed by the coordinate information generation circuit 22, followed by the operation of the processing circuit 32. Based on the processed result, the image display apparatus 40 displays a reference pattern not shown), and the user may move or tune (or magnify or minify) the display area 204 and/or the sensible area 203 such that the reference pattern overlaps with the predetermined center pattern 206. Or alternatively, the reference pattern and the predetermined center pattern 206 may be compared by a program, and the tuning guide for the user is displayed.

FIG. 9 shows another embodiment of the present invention, which shows a correction procedure for a rotation or tilt mismatch between the sensible area 203 and the display area 204. As shown in the figure, predetermined edge image data 208 corresponding to points at or near the boundary of the display area 204 (i.e., points at or around a corner or points at or around a side) are inputted to the image display apparatus 40, and predetermined edge patterns 209 are displayed correspondingly. If any of the predetermined edge patterns 209 is not sensed within the sensible area 203, it indicates that the sensible area 203 is too small, and the sensible area 203 may be magnified, or the display area 204 may be minified by a feedback control loop. On the other hand, if the predetermined edge pattern 209 is sensed within the sensible area 203, but a tilt or rotation mismatch between the display area 204 and the sensible area 203 exists as shown in the figure, the image sensor device 12 senses the predetermined edge pattern 209, and inputs the sensed image to the coordinate information generation circuit 22 to generate edge coordinate information. Next, the processing circuit 32 compares the edge coordinate information with the predetermined edge image data 208, and generates the correction value according to the comparison. The sensible area 203 or/and the display area 204 can be adjusted according to the correction value, such that the predetermined edge pattern 209 in the display area 204 matches the predetermined edge image data 208, i.e., the edge coordinate information matches the predetermined edge image data 208. The sensible area 203 and/or the display area 204 for example can be adjusted by adjusting the mechanical position of the image sensor device 12 and/or the image display apparatus 40 by a servo motor, or by tuning other related parameters of the image sensor device 12 and/or the image display apparatus 40. Or alternatively, information for adjustment can be shown as a tuning guide for the user.

Note that in general applications, the size of the sensible area 203 is preferably slightly larger than the size of the display area 204. By such arrangement, on the one hand, the image sensor device 12 can sense the action of the hand-held object within the entire display area 204; on the other hand, the resolution of the image sensor device 12 can be used efficiently. At the end of the correction procedure shown in FIG. 9, the predetermined edge pattern 209 in the display area 204 will match the predetermined edge image data 208, so the sizes of the sensible area 203 and the display area 204 are naturally optimized relative to each other.

The correction procedures shown in FIGS. 8-9 may be performed individually or in combination, one single time or repeated multiple times, till the center point and the edge points are all adjusted to an optimum condition.

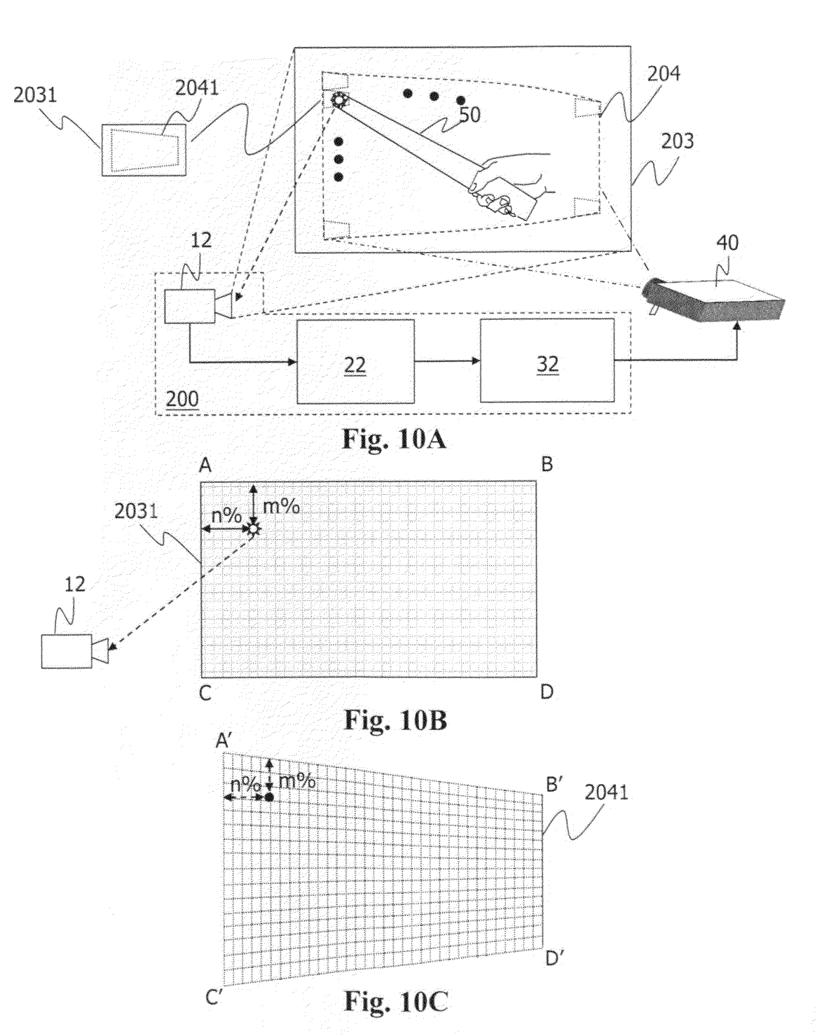

FIGS. 10A-10C show another embodiment of the present invention. This embodiment is an example about how to convert the coordinate information to the control signal according to the correction value, such that the image display apparatus 40 can display an image in response to the hand-held object to provide a better interactive effect.

As shown in FIG. 10A, an object tracking apparatus 200 includes the image sensor device 12, the coordinate information generation circuit 22, and the processing circuit 32. The image sensor device 12 senses the action of the hand-held object, and inputs a sensed result to the coordinate. information generation circuit 22. The hand-held object is for example but not limited to a hand-held pointer stick which emits infrared light, and the image sensor device 12 for example senses a position and a time period wherein the object stays at the position. The coordinate information generation circuit 22 processes the sensed result to generate coordinate information, which is inputted to the processing circuit 32. The processing circuit 32 generates image data which is inputted to the image display apparatus 40. In this way, the image display apparatus 40 displays an image related to the image data in response to the action of the hand-held object to create interactive effect, wherein the image display apparatus 40 is, for example but not limited to, a projector or a display screen. The sensible area 203 includes multiple sensible sub-areas 2031, corresponding to multiple display sub-areas 2041 in the display area 204. Each display sub-area 2041 may require a different correction value.

A user points the pointer stick 50 to a point in the display area 204. The image sensor device 12 senses that the pointer stick 50 is pointing at the sensible sub-area 2031, and corresponding to the display sub-area 2041 in the display area 204 which is displayed by the image display apparatus 40 according to a correction value that has been obtained in a correction procedure. Next, as an example shown in FIG. 10B, the sensible sub-area 2031 has corners A, B, C, and D. Horizontal segments AB and CD, and vertical segments AC and BD are divided into N sections and M sections respectively. By detecting the infrared light emitted from the pointer stick 50, it is found that the closest position to where the pointer stick 50 is pointed to is located at n % of the segment AB (or CD) in horizontal direction, and located at m % of the segment AC (or BD) in vertical direction.

As shown in FIG. 10C, the display sub-area 2041 has corners A′, B′, C′, and D′. Horizontal segments A′B′ and C′D′, and vertical segments A′ C′ and B′ D′ are divided into N sections and M sections respectively. Corresponding to the position at n % and m % of segment AB and AC in the sensible sub-area 2031 shown in FIG. 10B, an image, for example but not limited to a black point shown in FIG. 10C, is displayed at n % of the segment A′B′ in horizontal direction, and m % of the segment A′C′ in vertical direction, of the display sub-area 2041.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the image display apparatus 40 is not limited to the projector shown in the figures, but it may be for example a liquid crystal display (LCD) apparatus. For another example, the predetermined edge pattern 209 may be located at other edges or locations around other edges of the display area 204, not limited to the upper left corner and lower right corner of the display area 204 as shown in FIG. 9. In view of the foregoing, the spirit of the present invention should cover all such and other modifications and variations, which should be interpreted to fall within the scope of the following claims and their equivalents.

What is claimed is:

1. An object tracking apparatus, which generates a control signal according to an action of an object, the control signal being inputted to an image display apparatus to display an image in response to the action of the object, the object tracking apparatus comprising:
an image sensor device, which detects at least a predetermined pattern displayed by the image display apparatus to generate a sensed image;
a coordinate information generation circuit, which generates coordinate information according to the sensed image; and
a processing circuit, which generates a predetermined image data based on which the predetermined pattern is generated, wherein the processing circuit compares the coordinate information with the predetermined image data to generate a correction value.

2. The object tracking apparatus as claimed in claim 1, wherein the coordinate information includes a coordinate of a center point or an edge point of the sensed image.

3. The object tracking apparatus as claimed in claim 1, wherein the predetermined pattern includes a pattern formed by light within a predetermined wavelength range.

4. The object tracking apparatus as claimed in claim 3, wherein the image sensor device further includes a filter for filtering light out of the predetermined wavelength range.

5. The object tracking apparatus as claimed in claim 1, wherein the predetermined image data includes an image data corresponding to a point located at or around a center or an edge of a display area displayed by the image display apparatus.

6. The object tracking apparatus as claimed in claim 1, wherein the processing circuit converts the coordinate information to the control signal according to the correction value.

7. An interactive image display system, comprising:
an image display apparatus; and
an object tracking apparatus, which generates a control signal according to an action of an object, the control signal being inputted to the image display apparatus to display an image in response to the action of the object, the object tracking apparatus comprising:
an image sensor device, which detects at least a predetermined pattern displayed by the image display apparatus to generate a sensed image;
a coordinate information generation circuit, which generates coordinate information according to the sensed image; and
a processing circuit, which generates a predetermined image data based on which the predetermined pattern is generated, wherein the processing circuit compares the coordinate information with the predetermined image data to generate a correction value.

8. The interactive image display system as claimed in claim 7, wherein the coordinate information includes a coordinate of a center point or an edge point of the sensed image.

9. The interactive image display system as claimed in claim 7, wherein the predetermined pattern includes a pattern formed by light within a predetermined wavelength range.

10. The interactive image display system as claimed in claim 9, wherein the image sensor device further includes a filter for filtering light out of the predetermined wavelength range.

11. The interactive image display system as claimed in claim 7, wherein the predetermined image data includes an image data corresponding to a point located at or around a center or an edge of a display area displayed by the image display apparatus.

12. The interactive image display system as claimed in claim 7, wherein the processing circuit converts the coordinate information to the control signal according to the correction value.

13. A method of correcting an interactive image display system using an object tracking apparatus, wherein the object tracking apparatus generates a control signal according to an action of an object, the control signal being inputted to an image display apparatus to display an image in response to the action of the object, the method comprising:
displaying at least a predetermined pattern by the image display apparatus according to a predetermined image data;
sensing the predetermined pattern by an image sensor device to generating at least a sensed image;
processing the sensed image to generate a coordinate information; and
comparing the coordinate information with the predetermined image data to generate a correction value which is used for correcting the control signal, the image sensor device, or the image display apparatus.

14. The method as claimed in claim 13, wherein the coordinate information includes a coordinate of a center point or an edge point of the sensed image.

15. The method as claimed in claim 13, wherein the predetermined image data includes an image data corresponding to a point located at or around a center or an edge of a display area displayed by the image display apparatus.

16. The method as claimed in claim 13, wherein the step of displaying at least a predetermined pattern includes: displaying at least one predetermined pattern at different time points.

17. The method as claimed in claim 13, further comprising: converting the coordinate information to the control signal according to the correction value.

18. A method of correcting an image, comprising:
displaying a predetermined center pattern in a display area according to a predetermined center image data;
sensing the predetermined center pattern to generate a sensed image;
processing the sensed image to generate a center coordinate information;
comparing the center coordinate information with the predetermined center image data to generate a first correction value; and
correcting the center coordinate information according to the first correction value, such that the center coordinate information is aligned with the predetermined center image data.

19. The method as claimed in claim 18, further comprising:
displaying a plurality of predetermined edge patterns in the display area according to predetermined edge image data;
sensing the predetermined edge patterns to generate a plurality of sensed images;
processing the sensed images to generate edge coordinate information which includes a plurality of edge coordinates;
comparing the edge coordinates with the predetermined edge image data to generate a second correction value; and
correcting the edge coordinate information according to the second correction value, such that the edge coordinate information is aligned with the predetermined edge image data.

20. A method of correcting an image, comprising:
displaying a plurality of predetermined edge patterns in a display area according to predetermined edge image data;
sensing the predetermined edge patterns to generate a sensed image;
processing the sensed image to generate edge coordinate information which includes a plurality of edge coordinates;
comparing the edge coordinate information with the predetermined edge image data to generate a correction value; and
correcting the edge coordinate information according to the correction value, such that the edge coordinate information is aligned with the predetermined edge image data.
